(19) United States
(12) Patent Application Publication
(10) Pub. No.: US 2019/0347719 A1
(43) Pub. Date: Nov. 14, 2019

(54) VERIFICATION DEVICE AND METHOD TO VERIFY A USER FOR FACILITATING FINANCIAL ASSET

(71) Applicant: Tushar AGGARWAL, Green Cove Springs, FL (US)

(72) Inventor: Tushar AGGARWAL, Green Cove Springs, FL (US)

(21) Appl. No.: 15/979,267

(22) Filed: May 14, 2018

(51) Int. Cl. G06Q 40/02; G06Q 20/40

(52) U.S. Cl. CPC G06Q 40/025; G06Q 20/401

(57) ABSTRACT

The present disclosure provides a verification device to verify a user for facilitating financial asset. The verification device comprises of a communication circuitry, a memory, a signal generator and a control circuitry. The control circuitry associated with the financial asset system to perform a method which includes a step of receiving a first set of data associated with demographic information of the user and validating the first set of data. In addition, collects a second set of data associated with professional information of the user and verifying the second set of data. Further, receives a third set of data associated with banking information of the user and authenticating the third set of data. Furthermore, generate a profile of the user in real time. Moreover, verifying eligibility of the user for the financial asset. Also, the financial asset system allocates the financial asset to the user.

### TECHNICAL FIELD

The present disclosure relates to a field of financial asset system. More specifically, the present disclosure relates to a verification device to verify a user for facilitating financial asset.

### BACKGROUND

Financial institutions provide financial asset to individuals, businesses and the like. The financial asset includes personal loan, home loan, student loan, business loan, credit cards, and the like. Generally, the financial institutions receive a request from a borrower for borrowing the financial asset. The financial institutions perform a background check of the borrower for verification. The verification is performed to identify if the borrower is capable of repaying the financial asset. The background check is performed based on the limited personal and banking information furnished with the request for the financial asset. The financial asset is approved by the financial institutions for the borrower after verifying the borrower. Sometimes, the borrower provides fabricated information in order to get the financial asset. The fabricated information provided by the borrower passes the background check performed by the financial institutions. The background check performed by the financial institution does not prove to be effective for identifying if a person is capable to repay the financial asset. The background check performed by the financial institution is limited to the information provided by the borrower. In many cases, the financial institutions have to resort to other means for compensating for the amount associated with the financial asset. In one example, the financial institutions seize property or any other tangible asset of the borrower for repayment of the financial asset. There is a constant need to improve the verification process for avoiding loss incurred by the financial institutions.

### SUMMARY

In one aspect, the present disclosure provides a verification device to verify a user for providing financial asset. The verification device comprises of a communication circuitry for communicating information. Further, the verification device comprises a memory for storing information. Furthermore, the verification device comprises a signal generator circuitry for generating signal. Moreover, the verification device comprises a control circuitry associated with a financial asset system to perform a method for verification of the user for facilitating financial asset to the user. The method may include a first step of receiving a first set of data associated with demographic information of the user. In addition, the method may include a second step of validating the first set of data associated with the demographic information of the user. Further, the method may include a third step of collecting a second set of data associated with professional information of the user. Furthermore, the method may include a fourth step of verifying the second set of data associated with the professional information the user. Moreover, the method may include a fifth step of receiving a third set of data associated with banking information of the user. Also, the method may include a sixth step of authenticating the third set of data associated with the banking information the user. Also, the method may include a seventh step of generating a profile of the user in real time. Also, the method may include an eight step of verifying the eligibility of the user for approving the financial asset required by the user. Also, the method may include ninth step of allocating the financial asset to the user based on the verification and the eligibility of the user. The first set of data is received from the verification device. The validation is done by mapping the first set of data with data of the user obtained from the one or more web-based platform. The validation is done when the signal generator circuitry embedded inside the verification device generates a signal to perform the validation of the demographic information of the user. The validation is done in real time. The second set of data is collected from the verification device. The second set of data is collected after the validation of the first set of data. Verification is done by mapping the second set of data with the data of the user obtained from the one or more web-based platform. The verification is done when the signal generator circuitry embedded inside the verification device generates a signal to perform the verification of the professional information of the user. The verification is done in real time. The third set of data is received from the verification device. The third set of data is collected after the verification of the second set of data. Authentication is done by mapping the third set of data with the data of the user obtained from the one or more web-based platform. The authentication is done when the signal generator circuitry embedded inside the verification device generates a signal to perform the verification of the professional information of the user. The authentication is done in real time. The profile is generated based on the verification of the first set of data, the second set of data, the third set of data and the data obtained from the one or more web-based platform of the user. The financial asset required by the user is received from the third set of data. The verification is done based on the third set of data and profile of the user. The verification is done when the signal generator circuitry embedded inside the verification device generates a signal to perform the eligibility of the user. The verification is done to check the capability of user to repay the financial asset. The allocation is done to the user selected mode of transfer. The mode of transfer is the user account or card. The mode of transfer is received from the third set of data.

In an embodiment of the present disclosure, the first set of data is associated with the demographic information of the user. The first set of data includes name, last name, age, gender, father name, mother name, mobile number, address, e-mail address, and nationality of the user.

In an embodiment of the present disclosure, the second set of data is associated with the professional information of the user. The second set of data includes occupation, current designation, employment type, industry, company details, salary details, experience, pan card details, aadhaar card details, and passport information.

In an embodiment of the present disclosure, the third set of data associated with the banking information of the user. The third set of data includes bank account details, number of bank account associated with the user, number of credit cards hold by the user, number of debit card hold by the user, the financial asset, mode of transfer, rate of interest and time duration for repayment of the financial asset.

In an embodiment of the present disclosure, the method may include yet another step of storing at the financial asset system the first set of data, the second set of data, and the third set of data. The storing is done in real time.

In an embodiment of the present disclosure, the method may include yet another step of updating at the financial asset system the first set of data, the second set of data, and the third set of data. The updating is done in real time.

In an embodiment of the present disclosure, the method may include yet another step of calculating at the financial asset system standard salary based on the second set of data associated with the user. The standard salary is the salary provided to the user based on industry standards, current designation, and year of experience. Analyzing is done in real time.

In an embodiment of the present disclosure, the method may include yet another step of mapping at the financial asset system the second set of data with the calculated standard salary. The mapping is done to validate the user provided information for the financial asset.

In an embodiment of the present disclosure, the method may include yet another step of analyzing at the financial asset system the third set of data with the second set of data and data of the user obtained from the one or more web based platform. The analyzing is done to identify user behaviour. The analyzing is done by checking transaction location and current location of the user based on the data obtained from the one or more web based platform.

In an embodiment of the present disclosure, the verification device may include a touch screen display for allowing the user to interact with the verification device in real time and allow the user to enter information and make selection.

In an embodiment of the present disclosure, the communication circuitry communicates information between the verification device and the financial asset system in real time.

In an embodiment of the present disclosure, the signal generator circuitry embedded inside the verification device to trigger one or more hardware components associated with the verification device. The one or more hardware components are triggered to indicate the allocation of the financial asset to the user.

In a first example, a computer-implemented method is provided. The computer-implemented method to verify a user based on one or more web-based platform for facilitating financial asset to the user. The computer-implemented method may include a first step of receiving a first set of data associated with demographic information of the user. In addition, the computer-implemented method may include a second step of validating the first set of data associated with the demographic information of the user. Further, the computer-implemented method may include a third step of collecting a second set of data associated with professional information of the user. Furthermore, the computer-implemented method may include a fourth step of verifying the second set of data associated with the professional information the user. Moreover, the computer-implemented method may include a fifth step of receiving a third set of data associated with banking information of the user. Also, the computer-implemented method may include a sixth step of authenticating the third set of data associated with the banking information the user. Also, the computer-implemented method may include a seventh step of generating a profile of the user in real time. Also, the computer-implemented method includes an eight step of verifying the eligibility of the user for approving the financial asset required by the user. Also, the computer-implemented method may include ninth step of allocating the financial asset to the user based on the verification and the eligibility of the user. The first set of data is received from the verification device. The validation is done by mapping the first set of data with data of the user obtained from the one or more web-based platform. The validation is done when the signal generator circuitry embedded inside the verification device generates a signal to perform the validation of the demographic information of the user. The validation is done in real time. The second set of data is collected from the verification device. The second set of data is collected after the validation of the first set of data. Verification is done by mapping the second set of data with the data of the user obtained from the one or more web-based platform. The verification is done when the signal generator circuitry embedded inside the verification device generates a signal to perform the verification of the professional information of the user. The verification is done in real time. The third set of data is received from the verification device. The third set of data is collected after the verification of the second set of data. Authentication is done by mapping the third set of data with the data of the user obtained from the one or more web-based platform. The authentication is done when the signal generator circuitry embedded inside the verification device generates a signal to perform the verification of the professional information of the user. The authentication is done in real time. The profile is generated based on the verification of the first set of data, the second set of data, the third set of data and the data obtained from the one or more web-based platform of the user. The financial asset required by the user is received from the third set of data. The verification is done based on the third set of data and profile of the user. The verification is done when the signal generator circuitry embedded inside the verification device generates a signal to perform the eligibility of the user. The verification is done to check the capability of user to repay the financial asset. The allocation is done to the user selected mode of transfer. The mode of transfer is the user account or card. The mode of transfer is received from the third set of data.

In an embodiment of the present disclosure, the first set of data is associated with the demographic information of the user. The first set of data includes name, last name, age, gender, father name, mother name, mobile number, address, e-mail address, and nationality of the user.

In an embodiment of the present disclosure, the second set of data is associated with the professional information of the user. The second set of data includes occupation, current designation, employment type, industry, company details, salary details, experience, pan card details, aadhaar card details, and passport information.

In an embodiment of the present disclosure, the third set of data associated with the banking information of the user. The third set of data includes bank account details, number of bank account associated with the user, number of credit cards hold by the user, number of debit card hold by the user, the financial asset, mode of transfer, rate of interest and time duration for repayment of the financial asset.

In an embodiment of the present disclosure, the computer-implemented method may include yet another step of calculating at the financial asset system associated with the verification device standard salary based on the second set of data associated with the user. The standard salary is the salary provided to the user based on industry standards, current designation, and year of experience. Analyzing is done in real time.

In an embodiment of the present disclosure, the computer-implemented method may include yet another step of mapping at the financial asset system associated with the verification device the second set of data with the calculated standard salary. The mapping is done to validate the user provided information for the financial asset.

In an embodiment of the present disclosure, the computer-implemented method may include yet another step of analyzing at the financial asset system associated with the verification device the third set of data with the second set of data and data of the user obtained from the one or more web based platform. The analyzing is done to identify user behaviour. The analyzing is done by checking transaction location and current location of the user based on the data obtained from the one or more web based platform.

### BRIEF DESCRIPTION OF THE FIGURES

Having thus described the invention in general terms, reference will now be made to the accompanying drawings, which are not necessarily drawn to scale, and wherein:

FIG. 1 illustrates an interactive computing environment to verify a user for facilitating financial asset to the user, in accordance with various embodiments of the present disclosure;

FIG. 2A and FIG. 2B illustrate a flow chart for verifying the user for facilitating financial asset in real time, in accordance with various embodiments of the present disclosure; and

FIG. 3 illustrates a block diagram of a computing device, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

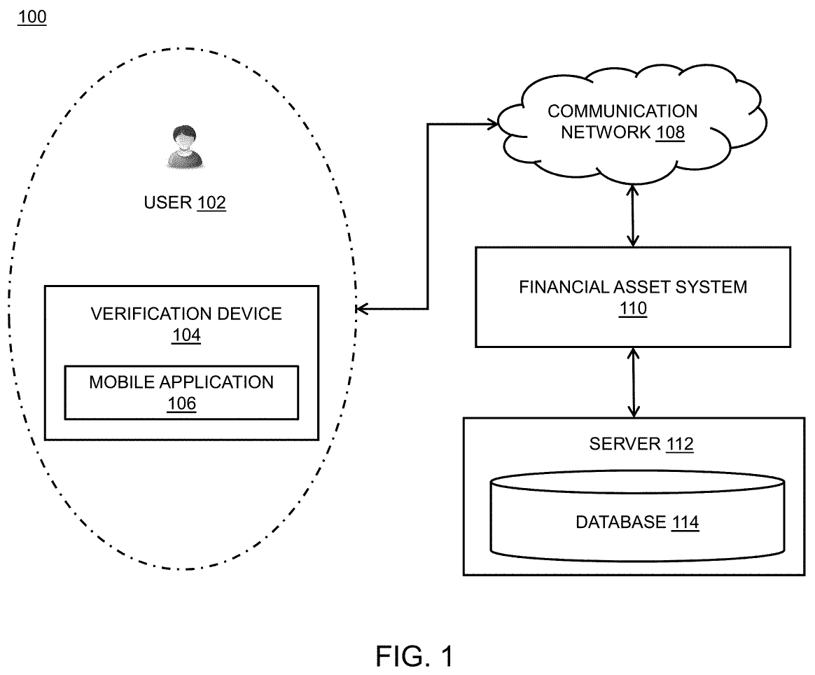

FIG.1 illustrates an interactive computing environment 100 for a verification device to verify a user 102 for facilitating financial asset to the user 102 with various embodiments of the present disclosure. The interactive computing environment 100 includes the user 102, the verification device 104, a mobile application 106, a communication network 108 and a financial asset system 110. In addition, the interactive computing environment 100 includes a server 112, and a database 114. The above-stated elements of the interactive computing environment collectively enable the verification device to verify a user 102 based on one or more web-based platform for facilitating the financial asset to the user 102.

In an embodiment of the present disclosure, the interactive computing environment 100 includes the user 102. The user 102 may be any person or individual looking for the financial asset. In addition, the user 102 may be any legal person or natural person who is in need of the financial asset for his own purpose. Further, the user 102 may be any person or individual looking for the minimum amount of the financial asset from online platforms.

In general, the financial asset is the asset provided to the user 102 for his use which is paid back after a particular period of time. The financial asset is intangible asset provided to the user 102. The financial asset is provided to the user 102 who is capable to repay the financial asset in future. The financial asset includes but is not limited to personal loan, student loan, business loan. In addition, the financial asset includes car loan, home loan, money, and the like. The financial asset is provided to the user 102 by financial institutions.

The financial institutions provide loan to the user 102 based on the verification and a guarantee that repayment of the financial asset will be done in the future with the suitable interest rate. The financial institutions provide the financial asset to the user 102 after verification based on certain terms and conditions which are to be followed by the user 102. The financial institutions include but are not limited to bank, money lenders, small investors. The financial institutions provide the financial asset to the user 102 which is to be repaid by the user 102 with in specified time. The financial institutions provide loan based on rate of interest which is to be paid by the user 102 in the future after completion of the specified period of time. The financial asset providing platform provides the financial asset to the user 102 based on the requirement of the financial asset to the user 102. Further, the financial institutions provide the financial asset to the user 102 after performing one or more steps of verification of the details of user to identify the capability of the user 102 to repay the financial asset within the specified time period. In an embodiment of the present disclosure, the user 102 is associated with the verification device 104.

In an example, the user 102 is the owner of the verification device 104. In another example, the user 102 may not be the owner of the verification device 104.

In an embodiment of the present disclosure, the verification device 104 is used for displaying and interfacing with the user 102. Further, the verification device 104 is a device which provides the financial asset to the user 102 based on verification from the one or more web-based platform. The verification device 104 includes a communication circuitry for communicating information between the verification device 104 and associated system in real time. In an embodiment of the present disclosure, the communication circuitry is a specially-configured hardware to perform specific operations based on the signal. In addition, the verification device 104 includes a memory for storing information. In an embodiment of the present disclosure, the memory may be volatile or non-volatile. The memory is used for storing the information which can be fetched based on the requirement.

Further, the verification device 104 includes a signal generator circuitry for generating signal and to trigger one or hardware component associated with the verification device 104. The one or more hardware components are triggered for one or more purposes. The one or more purposes includes but is not limited to inform user to enter information, to indicate the user has entered wrong data, to indicate the successful completion of the financial asset, and to indicate the eligibility of the user. The one or more purposes includes generate a signal based on the requirement of the financial asset system 110; indicate the allocation of the financial asset to the user 102, and the like.

Furthermore, the verification device 104 includes a control circuitry for controlling the operations of the verification device 104. The control circuitry performs all the operation and verifies the user 108 for providing the financial asset based on the verification. The control circuitry is associated with other system for performing the verification of the user 102. Moreover, the verification device 104 includes a touch screen display for allowing the user 102 to interact with the verification device 104 in real time and allow the user 102 to enter information and make selection.

In another embodiment of the present disclosure, the verification device 104 is any device which helps to communicate information and verify the user 102. The verification device 104 includes but is not limited to a Smartphone, a laptop, a desktop computer, a tablet and a personal digital assistant. In addition, the verification device 104 includes touch screen display in the mall, kiosk, and the like. In another embodiment of the present disclosure, the image capturing facility is enabled through one or more camera installed in the verification device 104. In yet another embodiment of the present disclosure, the audio facility is enabled through a microphone installed in the verification device 104. In yet another embodiment of the present disclosure, user interface is provided to the user through a touch-screen display installed in the verification device 104. In an embodiment of the present disclosure, the verification device 104 is currently in the switched-on state.

In an embodiment of the present disclosure, the verification device 104 is connected to the internet in real time. Further, the verification device 104 is associated with a specific type of operating system. The specific type of operating system includes an android operating system, a windows operating system, a Mac operating system and the like. Moreover, the verification device 104 is connected to the internet through a data connection provided by a telecom service provider. The telecom service provider is associated with a subscriber identification module card located inside the verification device 104. Also, the verification device 104 may be connected to the internet through the subscriber identification module card connection, Wi-Fi connection, hotspot connection and the like.

In yet another embodiment of the present disclosure, the verification device 104 may be accessed by the user 102 from inside and outside the interactive computing environment. In general, the verification device 104 is used for one or more purposes. In an example, the one or more purposes include entertainment, accessing web-based platforms for different tasks and the like. In another embodiment of the present disclosure, the verification device 104 is used for shopping, entertainment, learning, reading and the like.

In another embodiment of the present disclosure, the verification device includes the mobile application 106. Further, the mobile application 106 is installed inside the verification device 104. The mobile application 106 is used for performing one or more task on the verification device 104. The one or more task performed includes but is not limited to handling notification, connectivity, handling pre-programmed functions, handling request, respond to request. The mobile application 106 is installed on the verification device 104. In addition, the mobile application 106 is programmed to work on different platforms. Further, the mobile application 106 is used for opening the hardware of the verification device 104. Furthermore, the use of the mobile application 106 in online mode and offline mode depends on the type of application being used in the verification device 104. In an example, the mobile applications are used for entertaining, productivity, marketing and accessing various e-commerce and web-based platforms in online mode or offline mode. In an example, the mobile application 106 gets active when the verification device 104 is connected to the internet. In an embodiment of the present disclosure, the mobile application 106 is associated with financial asset providing platform. In addition, the mobile application 106 is used to access the financial asset providing platform.

In an example, a user X needs a financial asset. The user X came across a verification device. The verification device is having a mobile application of the financial asset platform. The mobile application shows an option for applying for the financial asset on the touch screen display of the peripheral device.

Further, the interactive computing environment 100 includes the communication network 108 associated with the verification device 104. The communication network 108 enables the financial asset system 110 to gain access to the internet. In an embodiment of the present disclosure, the communication network 108 provides a medium to transfer information between the verification device 104 and the financial asset system 110. Further, the medium of communication may be infrared, microwave, radio frequency (RF) and the like. The communication network 108 includes but may not be limited to a local area network, a metropolitan area network, a wide area network, a virtual private network. In addition, the communication network 108 includes but may not be limited to a global area network, a home area network or any other communication network presently known in the art. The communication network 108 is a structure of various nodes or communication devices connected to each other through a network topology method. Examples of the network topology include a bus topology, a star topology, a mesh topology and the like.

Furthermore, the interactive computing environment includes the financial asset system 110 which is associated with the verification device 104 through the communication network 108. The financial asset system 110 performs a method for the verification of the user 102 for providing financial asset to the user 102. The financial asset system 110 performs the method of verifying the user 102 and providing the financial asset to the user 102. The financial asset system 110 performs verification of the user 102 based on the information collected from the user 102 and the collected data from the one or more web-based platform. The financial asset system 110 performs a method to verify the user 102 by performing sequence of tasks which includes verifying the user entered information, capturing image of the user, verifying the image of the user, and the like. The financial asset system 110 verify the user 102 by performing sequence of tasks which includes creating profile of the user, check the eligibility of the user, and providing the financial asset to the user, and the like.

In an embodiment of the present disclosure, the financial asset system 110 receives a first set of data from the verification device 104. The first set of data is associated with demographic information of the user 102. The user 102 access the mobile application 106 on the verification device 104 for getting the financial asset from the financial institution. The user 102 enters the demographic information through the touch screen display of the verification device 104. The demographic information includes information regarding identity of the user 102. In an embodiment of the present disclosure, the demographic information includes name, last name, age, gender, father name, mother name, mobile number, and the like. In another embodiment of the present disclosure, the demographic information includes permanent address, correspondence address, e-mail address, and nationality of the user. In another embodiment of the present disclosure, the demographic information includes any other suitable information required for providing financial asset to the user 102.

In addition, the financial asset system 110 validates the first set of data associated with the demographic information of the user 102. The validation is done by mapping the first set of data with data of the user obtained from the one or more web-based platform. The validation is done when a signal generator circuitry embedded inside the verification device 104 generates a signal to perform the validation of the demographic information of the user 102. The validation is done in real-time. The one or more web-based platforms are the online platform on which there is account associated with the user 102. The account on the one or more web-based platforms includes cached data of the user 102, user behaviour, user friends, user accessed information, and the like. The one or more web-based platforms include social network platform, e-commerce platform, banking platform and the like. In addition, the data of the user 102 available on the one or more web-based platforms includes information of the user 102 available on the one or more social networking platforms. The one or more social networking platform includes facebook, instagram, LinkedIn, orkut whatsaap, twitter, and the like. Further, the user 102 accesses the one or more web-based platform on a regular basis for updating his information on the one or more web-based platform. The financial asset system 110 validates the first set of data after receiving the first set of data from the user 102.

In an example, user X is applying for the financial asset. The user X enters his demographic information using the touch screen display of the peripheral device. The user submits his demographic information. The submitted demographic information is taken as first set of data which is sent to the financial asset system through the communication network. The financial asset system initiates a signal generator circuitry embedded inside the peripheral device to generate a signal. The signal generated performs the task of validating the first set of data with the information of the user available on the web-based platform. The user X is having account on Facebook, LinkedIn and twitter. The financial asset system maps the demographic information entered by the user with the information available on the facebook, LinkedIn and twitter.

Further, the financial asset system 110 collects a second set of data from the verification device 104. The second set of data is collected after validation of the first set of data. The second set of data is associated with professional information of the user 102. The user 102 enters the professional information through the touch-screen display of the verification device. In an embodiment of the present disclosure, the professional information includes occupation, current designation, employment type, industry, company details, and the like. In addition, the professional information includes but is not limited to salary details, experience, pan card details, aadhaar card details, and passport information. In another embodiment of the present disclosure, the professional information includes any other suitable information required for verifying and providing financial asset to the user 102.

Furthermore, the financial asset system 110 verifies the second set of data associated with the professional information of the user 102. The verification is done by mapping the professional information of the user 102 with the data of the user available on the one or more web-based platforms. The verification is done when the signal generator circuitry embedded inside the verification device 104 generates a signal to perform the verification of the professional information of the user 102. The verification is done in real-time.

In an embodiment of the present disclosure, the financial asset system 110 calculates a standard salary based on the second set of data associated with the user 102. The standard salary is the salary provided to the user 102 based on industry standards, current designation, and year of experience. The calculation is done in real time. The industry standards are the standards based on the field of work, relevant experience in the field, soft skills required at the designation and the like.

In an embodiment of the present disclosure, the financial asset system 110 maps the second set of data with the calculated standard salary. The mapping is done to validate the user provided information for the financial asset. The second set of data is mapped with the standard salary to verify with the user entered salary details. In an embodiment of the present disclosure, the mapping also provide the information if the user is capable of repayment of the financial asset in the future.

In an example, the standard salary for a person working at the current designation of manager with 1 year of relevant experience is expected to have a standard salary of 10,000 USD. If the user has entered 15,000 USD as the salary in the second set of data, the financial asset system performs mapping of the standard salary with the salary of the user collected in the second set of data which will show deviation from the standard salary. The financial asset system will mark the user provided information for further verification.

Moreover, the financial asset system 110 receives a third set of data from the verification device 104. The third set of data is associated with banking information of the user 102. The third set of data is collected after verification of the second set of data. The user 102 enters the banking information through the touch-screen display of the verification device. In an embodiment of the present disclosure, the banking information includes bank account details, number of bank account associated with the user, number of credit cards and debit cards accessed by the user, and the like. In another embodiment of the present disclosure, the banking information includes financial asset, mode of transfer, and the like. In yet another embodiment of the present disclosure, the banking information includes but is not limited to rate of interest and time duration for repayment of the financial asset. In yet another embodiment of the present disclosure, the banking information includes any other suitable information required for authenticating and providing financial asset to the user 102.

Also, the financial asset system 110 authenticates the third set of data associated with the banking information of the user 102. The authentication is done by mapping the third set of data with the data of the user available on the one or more web-based platforms. The authentication is done when the signal generator circuitry embedded inside the verification device 104 generates a signal to perform the authentication of the banking information of the user 102. The authentication is done in real-time.

In an embodiment of the present disclosure, the financial asset system 110 analysis the third set of data with the second set of data and data of the user obtained from the one or more web based platform. The analysis is done to identify the user behaviour. The analyzing is done by checking the transaction location and the current location of the user 102 based on the data obtained from the one or more web based platform. The user behaviour is the behaviour or user pattern which involves the transaction history of the user 102 and location of the user 102. In an example, if user X has done a transaction at Amsterdam location using the card and the current location of the user on the one or more web-based platform shows Paris than based on the analysis it is identified there is mismatch in the user location. In such case the location where the user has done the card transaction will be taken into consideration as it will show the correct accurate location of the user which will be verified by the financial asset system.

Also, the financial asset system 110 generates a profile of the user 102 in real time. The profile is generated based on the verification of the first set of data, the second set of data, the third set of data and the data obtained from the one or more web-based platform of the user. The profile of the user 102 is generated to get a risk profile of the user 102 based on the information of the first set of data, the second set of data, the third set of data, and the data of the user collected from the one or more web-based platform of the user 102. Further, the profile of the user 102 is used to decide the minimum amount of the financial asset which may be rendered to the user 102.

Also, the financial asset system 110 verifies eligibility of the user 102 for approving the financial asset entered by the user in the third set of data. The verification is done based on the third set of data and the profile of the user 102. The verification is done when the signal generator circuitry embedded inside the verification device generates a signal to perform the eligibility of the user 102. The verification is done to check the capability of user to repay the financial asset. The verification is done based on the information provided by the user 102. The verification helps to identify eligibility if the user will be able to repay the financial asset. The verification is done by the financial institution before allocating the financial asset to the user 102. In an embodiment of the present, the financial asset system 110 provides the financial asset to the user 102 after the successful verification of the user 102.

Also, the financial asset system 110 receives the mode of transfer from the third set of data entered by the user 102. The user 102 selected mode of transfer is used for transferring the financial asset to the user 102. In an embodiment of the present disclosure, the mode of transfer is user account, card, and the like. Further, the financial asset system 110 allocates the financial asset to the user 102 based on the verification and the eligibility of the user 102 into the user 102 selected mode of transfer.

In an embodiment of the present disclosure, the financial asset system 110 updates the first set of data, the second set of data, and the third set of data. In addition, the financial asset system 110 updates all the data stored in the database 114 in real time.

In an embodiment of the present disclosure, the financial asset system 110 stores the first set of data, the second set of data, and the third set of data. In addition, the financial asset system 110 updates all the data stored in the database 114 in real time.

In an embodiment of the present disclosure, the financial asset system 110 indicates a failure to the user 102 through a signal, if the user does not fulfill the eligibility for the financial asset. In another embodiment of the present disclosure, if the user 102 does not get verified based on the information provided by the user 102 the financial asset is not provided to the user 102. In yet another embodiment of the present disclosure, if the user 102 is eligible for the financial asset which is less than the financial asset entered by the user 102 the mobile application 106 shows a message. The message on the mobile application 106 includes the financial asset which can be provide to the user 102 based on the verification of the user 102.

In another embodiment of the present disclosure, the financial asset system 110 analyses the user behaviour with the second set of data, third set of data and the data of the user from the one or more web-based platform of the user 102. The analyses help to identify expense of the user 102. The expense of the user 102 provide the information regarding the user 102 background which helps the financial asset system to identify if the user will be able to repay the financial asset based on expenses and the salary of the user.

In an embodiment of the present disclosure, the financial asset system 110 requires one or more documents associated with the identity of the user 102. The user 102 upload the documents on the mobile application 106 while providing the first set of data, the second set of data and the third set of data. In an example, the user 102 uploads softcopy of PAN card, aadhaar card, mark sheet, birth certificate and the like.

In an embodiment of the present disclosure, the financial asset system 110 is associated with the server 112. In addition, the server 112 performs all the tasks related to the handling of the verification device 104. The server 112 receives the requests from the verification device and processes these requests. In an example, the server 112 receives the request of the financial asset from the verification device 104.

The server 112 responds to the requests in an efficient manner. In an example, the server 112 is present inside the financial asset system 110. In another example, the server 112 is remotely located. In yet another embodiment of the present disclosure, the server 112 is a cloud server. The analysis of data, creating the profile of the user, storing data is done on the cloud server. The server 112 handles each operation and task performed by the financial asset system 110. The server 112 stores one or more instructions for performing the various operations of the financial asset system 110. In addition, the server 112 comprises the database 114. The database 114 is the storage location of all the data associated with the financial asset system 110. In an embodiment of the present disclosure, the financial asset system 110 stores the first set of data, the second set of data, and the third set of data in the database 114 for future requirement.

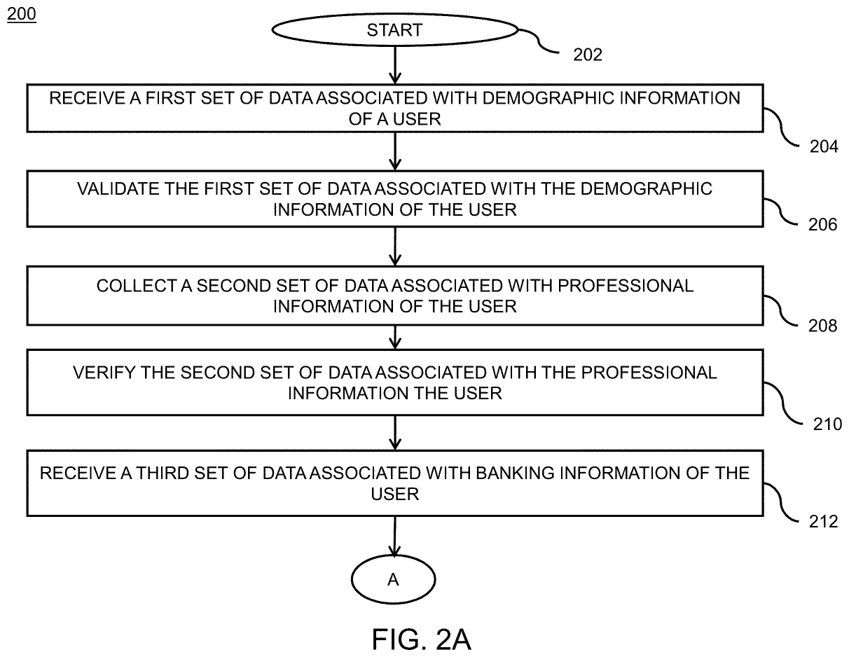

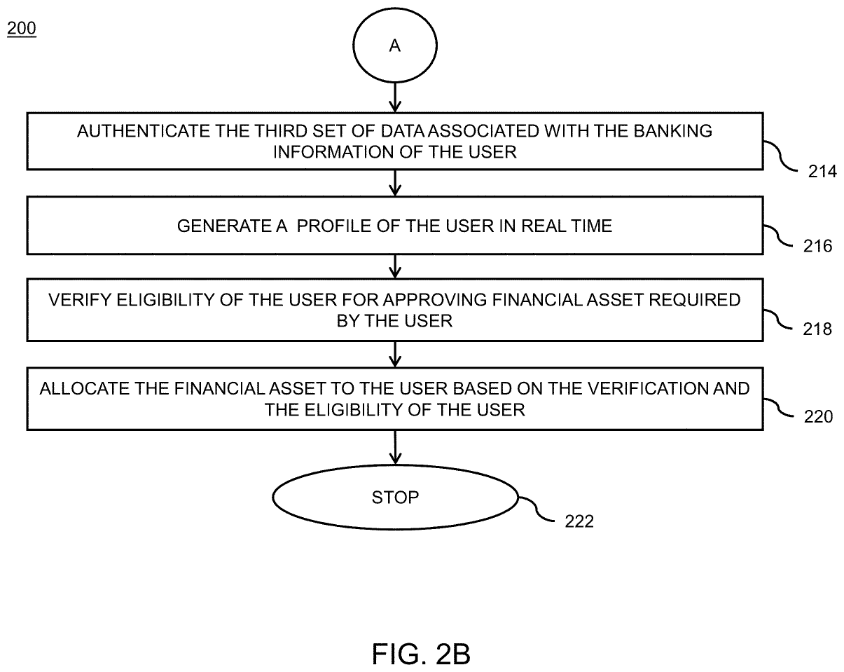

FIG. 2A and FIG. 2B illustrates a flow chart 200 to verify a user based on the one or more web-based platform for facilitating the financial asset to the user 102, in accordance with various embodiments of the present disclosure. It may be noted that to explain the process steps of flowchart 200, references will be made to the system elements of FIG. 1. It may also be noted that the flowchart 200 may have lesser or more number of steps.

The flowchart 200 initiates at step 202. Following step 202, at step 204, the financial asset system 110 receives the first set of data associated with the demographic information of the user 102. At step 206, the financial asset system 110 validates the first set of data associated with the user 102 by mapping the demographic information of the user 102 with the data of the user 102 available on the one or more web-based platform. At step 208, the financial asset system 110 collects the second set of data associated with the professional information of the user 102. At step 210, the financial asset system 110 verifies the second set of data associated with the user 102 by mapping the professional information of the user 102 with the data of the user 102 available on the one or more web-based platform. At step 212, the financial asset system 110 receives the third set of data associated with banking information of the user. At step 214, the financial asset system 110 authenticates the third set of data associated with the user 102 by mapping the banking information of the user 102 with the data of the user 102 available on the one or more web-based platform. At step 216, the financial asset system 110 generates the profile of the user 102 based on the verification of the first set of data, the second set of data and the third set of data. At step 218, the financial asset system 110 verifies the eligibility of the user 102 for approving the financial asset to the user 102. At step 220, the financial asset system 110 allocates the financial asset to the user 102 based on the verification and eligibility of the user 102. The flow chart 200 terminates at step 222.

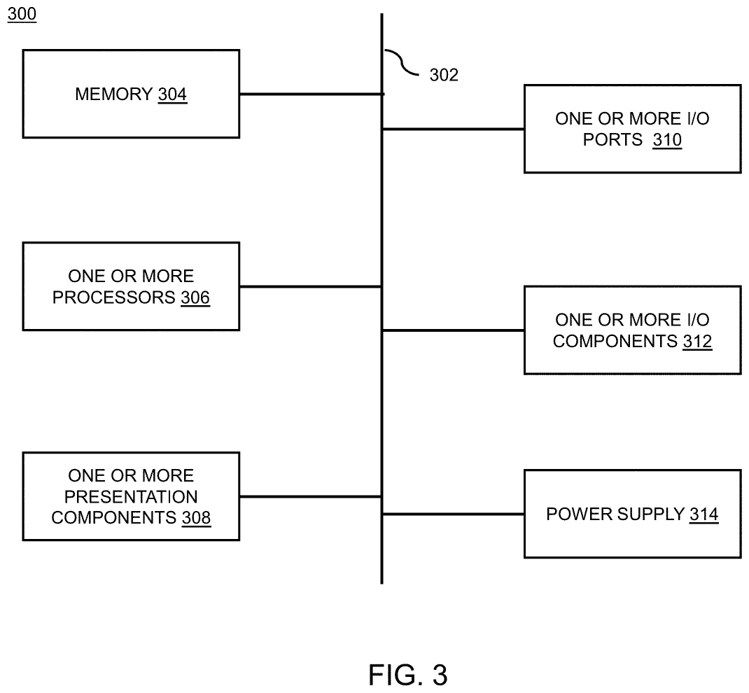

FIG. 3 illustrates a block diagram of a computing device 300, in accordance with various embodiments of the present disclosure. The computing device 300 includes a bus 302 that directly or indirectly couples the following devices: memory 304, one or more processors 306, one or more presentation components 308, one or more input/output (I/O) ports 310, one or more input/output components 312, and an illustrative power supply 314. The bus 302 represents what may be one or more busses (such as an address bus, data bus, or combination thereof). Although the various blocks of FIG. 3 are shown with lines for sake of clarity, in reality, delineating various components is not so clear, and metaphorically, the lines would more accurately be grey and fuzzy. For example, one may consider a presentation component such as a display device to be an I/O component. Also, processors have memory. FIG. 3 is merely illustrative of an exemplary computing device 300 may be used in connection with one or more embodiments of the present disclosure. Distinction is not made between such categories as workstation, server, laptop, hand-held device and the like, as all are contemplated within the scope of FIG. 3 and reference to “the computing device 300.”

The computing device 300 typically includes a computer-readable media. The computer-readable media can be any available media that can be accessed by the computing device 300 and includes both volatile and nonvolatile media, removable and non-removable media. By way of example, and not limitation, the computer-readable media may comprise computer storage media and communication media. The computer storage media includes the volatile and the nonvolatile, the removable and the non-removable media implemented in any method or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 300. The communication media typically embodies the computer-readable instructions, the data structures, the program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, the communication media includes wired media such as a wired network or direct-wired connection, and wireless media such as acoustic, RF, infrared and other wireless media. Combinations of any of the above should also be included within the scope of the computer readable media.

Memory 304 includes the computer-storage media in the form of volatile and/or nonvolatile memory. The memory 304 may be removable, non-removable, or a combination thereof. Exemplary hardware devices include solid-state memory, hard drives, optical-disc drives and the like. The computing device 300 includes the one or more processors to read data from various entities such as memory 304 or I/O components 312. The one or more presentation components 308 present data indications to a user or other device. Exemplary presentation components include a display device, speaker, printing component, vibrating component and the like. The one or more I/O ports 310 allow the computing device 300 to be logically coupled to other devices including the one or more I/O components 312, some of which may be built in. Illustrative components include a microphone, joystick, game pad, satellite dish, scanner, printer, wireless device and the like.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed:

1. A verification device to verify a user for providing financial asset, the verification device comprising:
a communication circuitry for communicating information;
a memory for storing information;
a signal generator circuitry for generating a signal; and
a control circuitry associated with a financial asset system to perform a method for verification of the user for facilitating financial asset to the user, the method comprising:
receiving, at the financial asset system associated with the verification device, a first set of data associated with demographic information of the user, wherein the first set of data is received from the verification device;
validating, at the financial asset system associated with the verification device, the first set of data associated with the demographic information of the user, wherein the validation is done by mapping the first set of data with data of the user obtained from one or more web-based platform, wherein the validation is done when the signal generator circuitry embedded inside the verification device generates a signal to perform the validation of the demographic information of the user and wherein the validation is done in real time;
collecting, at the financial asset system associated with the verification device, a second set of data associated with professional information of the user, wherein the second set of data is collected from the verification device, wherein the second set of data is collected after the validation of the first set of data;
verifying, at the financial asset system associated with the verification device, the second set of data associated with the professional information of the user, wherein the verification is done by mapping the second set of data with the data of the user obtained from the one or more web-based platform, wherein the verification is done when the signal generator circuitry embedded inside the verification device generates a signal to perform the verification of the professional information of the user, and wherein the verification is done in real time;
receiving, at the financial asset system associated with the verification device, a third set of data associated with banking information of the user, wherein the third set of data is received from the verification device, wherein the third set of data is collected after the verification of the second set of data;
authenticating, at the financial asset system associated with the verification device, the third set of data associated with the banking information of the user, wherein the authentication is done by mapping the third set of data with the data of the user obtained from the one or more web-based platform, wherein the authentication is done when the signal generator circuitry embedded inside the verification device generates a signal to perform the verification of the professional information of the user, and wherein the authentication is done in real time;
generating, at the financial asset system associated with the verification device, a profile of the user in real time, wherein the profile is generated based on the verification of the third set of data and the data obtained from the one or more web-based platform of the user;
verifying, at the financial asset system associated with the verification device, eligibility of the user for approving the financial asset required by the user, wherein the financial asset required by the user is received from the third set of data, wherein the verification is done based on the third set of data and the profile of the user, wherein the verification is done when the signal generator circuitry embedded inside the verification device generates a signal to perform the eligibility of the user, wherein the verification is done to check capability of the user to repay the financial asset; and
allocating, at the financial asset system associated with the verification device, the financial asset to the user based on the verification and the eligibility of the user, wherein the allocation is done to the user selected mode of transfer, wherein the mode of transfer is user account or card, wherein the mode of transfer is received from the third set of data.

2. The verification device as recited in claim 1, wherein the first set of data is associated with the demographic information of the user, wherein the first set of data comprises name, last name, age, gender, father name, mother name, mobile number, address, e-mail address, and nationality of the user.

3. The verification device as recited in claim 1, wherein the second set of data is associated with the professional information of the user, wherein the second set of data comprises occupation, current designation, employment type, industry, company details, salary details, experience, pan card details, aadhaar card details, and passport information.

4. The verification device as recited in claim 1, wherein the third set of data is associated with the banking information of the user, wherein the third set of data comprises bank account details, number of bank account associated with the user, number of credit cards hold by the user, number of debit cards hold by the user, the financial asset, the mode of transfer, rate of interest and time duration for repayment of the financial asset.

5. The verification device as recited in claim 1, further comprising storing, at the financial asset system associated with the verification device, the first set of data, the second set of data, and the third set of data, and wherein the storing is done in real time.

6. The verification device as recited in claim 1, further comprising updating, at the financial asset system associated with the verification device, the first set of data, the second set of data, and the third set of data, and wherein the updating is done in real time.

7. The verification device as recited in claim 1, further comprising calculating, at the financial asset system associated with the verification device, standard salary based on the second set of data associated with the user, wherein the standard salary is salary provided to the user based on industry standards, current designation, and year of experience, wherein the calculation is done in real time.

8. The verification device as recited in claim 1, further comprising mapping, at the financial asset system associated with the verification device, the second set of data with the calculated standard salary, wherein the mapping is done to validate user provided information for the financial asset.

9. The verification device as recited in claim 1, further comprising analyzing, at the financial asset system associated with the verification device, the third set of data with the second set of data and the data of the user obtained from the one or more web based platform, wherein analyzing is done to identify user behaviour, wherein the analyzing is done by checking transaction location and current location of the user based on the data obtained from the one or more web based platform.

10. The verification device as recited in claim 1, wherein the verification device comprises of a touch screen display for allowing the user to interact with the verification device in real time and allow the user to enter information and make selection.

11. The verification device as recited in claim 1, wherein the communication circuitry communicates information between the verification device and the financial asset system in real time.

12. The verification device as recited in claim 1, wherein the signal generator circuitry embedded inside the verification device to trigger one or more hardware components associated with the verification device, wherein the one or more hardware components are triggered to indicate the allocation of the financial asset to the user.

13. A computer-implemented method to verify a user based on one or more web-based platform for facilitating financial asset to the user, the computer-implemented method comprising:
receiving, at a financial asset system associated with a verification device, a first set of data associated with demographic information of the user, wherein the first set of data is received from the verification device;
validating, at the financial asset system associated with the verification device, the first set of data associated with the demographic information of the user, wherein the validation is done by mapping the first set of data with data of the user obtained from the one or more web-based platform, wherein the validation is done when a signal generator circuitry embedded inside the verification device generates a signal to perform the validation of the demographic information of the user, and wherein the validation is done in real time;
collecting, at the financial asset system associated with the verification device, a second set of data associated with professional information of the user, wherein the second set of data is collected from the verification device, wherein the second set of data is collected after the validation of the first set of data;
verifying, at the financial asset system associated with the verification device, the second set of data associated with the professional information the user, wherein the verification is done by mapping the second set of data with the data of the user obtained from the one or more web-based platform, wherein the verification is done when the signal generator circuitry embedded inside the verification device generates a signal to perform the verification of the professional information of the user, and wherein the verification is done in real time;
receiving, at the financial asset system associated with the verification device, a third set of data associated with banking information of the user, wherein the third set of data is received from the verification device, wherein the third set of data is collected after the verification of the second set of data;
authenticating, at the financial asset system associated with the verification device, the third set of data associated with the banking information of the user, wherein the authentication is done by mapping the third set of data with the data of the user obtained from the one or more web-based platform, wherein the authentication is done when the signal generator circuitry embedded inside the verification device generates a signal to perform the verification of the professional information of the user, and wherein the authentication is done in real time;
generating, at the financial asset system associated with the verification device, a profile of the user in real time, wherein the profile is generated based on the verification of the third set of data and the data obtained from the one or more web-based platform of the user;
verifying, at the financial asset system associated with the verification device, eligibility of the user for approving the financial asset required by the user, wherein the financial asset required by the user is received from the third set of data, wherein the verification is done based on the third set of data and the profile of the user, wherein the verification is done when the signal generator circuitry embedded inside the verification device generates a signal to perform the eligibility of the user, wherein the verification is done to check capability of the user to repay the financial asset; and
allocating, at the financial asset system associated with the verification device, the financial asset to the user based on the verification and the eligibility of the user, wherein the allocation is done to the user selected mode of transfer, wherein the mode of transfer is user account or card, wherein the mode of transfer is received from the third set of data.

14. The computer-implemented method as recited in claim 13, wherein the first set of data is associated with the demographic information of the user, wherein the first set of data comprises name, last name, age, gender, father name, mother name, mobile number, address, e-mail address, and nationality of the user.

15. The computer-implemented method as recited in claim 13, wherein the second set of data is associated with the professional information of the user, wherein the second set of data comprises occupation, current designation, employment type, industry, company details, salary details, experience, pan card details, aadhaar card details, and passport information.

16. The computer-implemented method as recited in claim 13, wherein the third set of data is associated with the banking information of the user, wherein the third set of data comprises bank account details, number of bank account associated with the user, number of credit cards hold by the user, number of debit cards hold by the user, the financial asset, the mode of transfer, rate of interest and time duration for repayment of the financial asset.

17. The computer-implemented method as recited in claim 13, further comprising calculating, at the financial asset system associated with the verification device, standard salary based on the second set of data associated with the user, wherein the standard salary is salary provided to the user based on industry standards, current designation, and year of experience, wherein the calculation is done in real time.

18. The computer-implemented method as recited in claim 13, further comprising mapping, at the financial asset system associated with the verification device, the second set of data with the calculated standard salary, wherein the mapping is done to validate user provided information for the financial asset.

19. The computer-implemented method as recited in claim 13, further comprising analyzing, at the financial asset system associated with the verification device, the third set of data with the second set of data and the data of the user obtained from the one or more web based platform, wherein the analyzing is done to identify user behaviour, wherein the analyzing is done by checking transaction location and current location of the user based on the data obtained from the one or more web based platform.

20. The computer-implemented method as recited in claim 13, wherein the signal generator circuitry embedded inside the verification device to trigger one or more hardware components associated with the verification device, wherein the one or more hardware components are triggered to indicate the allocation of the financial asset to the user.
